(19) United States
(12) Patent Application Publication
(10) Pub. No.: US 2025/0229844 A1
(43) Pub. Date: Jul. 17, 2025

(54) VEHICLE LOWER STRUCTURE

(71) Applicant: TOYOTA JIDOSHA KABUSHIKI KAISHA, Toyota-shi (JP)

(72) Inventor: Takeshi MIKA, Nisshin-city (JP)

(73) Assignee: TOYOTA JIDOSHA KABUSHIKI KAISHA, Toyota-shi (JP)

(21) Appl. No.: 19/018,253

(22) Filed: Jan. 13, 2025

(30) Foreign Application Priority Data
Jan. 16, 2024 (JP) 2024-004349

(51) Int. Cl. B62D 25/20; B60N 2/005; B62D 25/02

(52) U.S. Cl. CPC B62D 25/2036; B60N 2/005; B62D 25/025

(57) ABSTRACT

The vehicle lower structure includes a rocker, a floor cross member, a gusset, and a seat bracket. The seat bracket is an elongated member extending in the vehicle width direction, and a low-strength portion is provided at the center in the longitudinal direction. The floor cross member is provided with a strength reduced portion at a position corresponding to the low-strength portion. The pressing flange on the vehicle width direction inner side of the gusset is connected to the side end portion of the floor cross member so as to overlap the strength reduced portion.

### CROSS REFERENCE TO RELATED APPLICATION

This application claims priority to Japanese Patent Application No. No. 2024-004349 filed on January 16 2024, which is incorporated herein by reference in its entirety including the specification, claims, drawings, and abstract.

### TECHNICAL FIELD

The present disclosure relates to a structure of a lower portion of a vehicle.

### BACKGROUND

A structure for absorbing impact energy at the time of a side collision of a vehicle has been proposed. For example, JP 2022-43808 A discloses a structure in which a step portion is provided on a seat bracket provided on an upper portion of a floor cross member. In this structure, when a side collision occurs in the vehicle, the step portion is bent and deformed to absorb the impact energy. In this structure, when a side collision occurs in the vehicle, the step portion is bent and deformed to absorb the impact energy.

By the way, due to deformation of the floor cross member at the time of the side collision, the floor panel may be broken. In particular, when the folding position of the floor cross member at the time of the side collision cannot be controlled, the floor panel may be broken. On the other hand, in recent years, in order to improve safety at the time of a side collision, it is required to suppress damage to the floor panel at the time of a side collision.

Therefore, an object of the present disclosure is to control a folding position of a floor cross member and suppress damage to a floor panel at the time of a side collision.

### SUMMARY

A vehicle lower structure according to the present disclosure includes: a rocker disposed on a side portion of a vehicle and extending in longitudinal direction of the vehicle; a floor cross member connected to the rocker and extending in a vehicle width direction; a gusset connected to a side end portion of the floor cross member and an inner surface of the rocker in the vehicle width direction; and a seat bracket disposed apart from the rocker and attached to the floor cross member, the seat bracket being attached so as to straddle the side end portion and a general portion of the floor cross member. The general portion is adjacent to an inner side of the side end portion in the vehicle width direction. The seat bracket is an elongated member extending in the vehicle width direction, and is provided with a low-strength portion at a center in a longitudinal direction thereof. The floor cross member is provided with a strength reduced portion at a position corresponding to the low-strength portion. The gusset is connected to the side end portion of the floor cross member such that an inner end thereof in the vehicle width direction overlaps the strength reduced portion.

As a result, a downward force is transmitted from the gusset to the strength reduced portion at the time of a side collision, the seat bracket is bent downward with the low-strength portion as a bending starting point, and the floor cross member is bent downward with the strength reduced portion provided at a position corresponding to the low-strength portion as a starting point. As described above, according to the present disclosure, the folding position of the floor cross member can be controlled, and the deformation amount of the floor panel at the time of the side collision can be reduced.

In the vehicle lower structure of the present disclosure, the floor cross member may be connected to a lower portion of the rocker. The gusset may be connected to the inner surface of the rocker in the vehicle width direction above the floor cross member. The seat bracket may be an inverted U-shaped cross-sectional member extending in the vehicle width direction, and is attached to the floor cross member so as to cover the gusset from above.

With this configuration, the rocker deforms in the upward direction at the time of the side collision, and the seat bracket and the floor cross member are deformed by being bent downward. Then, the seat bracket in the portion outside the low-strength portion in the vehicle width direction, the floor cross member outside the strength reduced portion in the vehicle width direction, and the gusset are deformed upward so as to overlap each other. Further, they deform toward the vehicle width direction inner side. Thus, impact energy can be absorbed.

In the vehicle lower structure of the present disclosure, the seat bracket may be an inverted U-shaped cross-sectional member including a top plate, a front plate, and a rear plate. The low-strength portion may be an inverted U-shaped notch provided in the front plate and the rear plate. A portion of the front plate at an outer side of the notch in the vehicle width direction and a portion of the rear plate at an outer side of the notch in the vehicle width direction may be connected to the side end portion at an outer side of the strength reduced portion in the vehicle width direction. A portion of the front plate at an inner side of the notch in the vehicle width direction and a portion of the rear plate at an inner side of the notch in the vehicle width direction may be connected to the general portion at an inner side of the strength reduced portion in the vehicle width direction.

With this configuration, the vehicle width direction outer side portion and the vehicle width direction inner side portion of the notches of the front plate and the rear plate of the seat bracket deform such that the lower portion opens along the vehicle width direction at the time of a side collision, and the lower portion is bent and deformed downward at the low strength portion. Further, the floor cross member is bent downward at the strength reduced portion. Thus, the bending position of the floor cross member can be controlled, and the deformation amount of the floor panel at the time of the side collision can be reduced.

In the vehicle lower structure of the present disclosure, the floor cross member may be a hat-shaped cross-sectional member including a web, a front flange, and a rear flange, with the web disposed at an upper position. The strength reduced portion may be a slit provided in the web and extending in the vehicle longitudinal direction.

With this configuration, the folding position of the floor cross member can be controlled with a simple structure, and damage to the floor panel at the time of side collision can be suppressed. Further, the impact energy can be absorbed with a simple structure.

In the vehicle lower structure of the present disclosure, the floor cross member may be a hat-shaped cross-sectional member including a web, a front flange, and a rear flange, with the web disposed at an upper position. The strength reduced portion may be folded beads provided on a front connecting ridge line between the web and the front flange and on a rear connecting ridge line between the web and the rear flange.

With this configuration, the folding position of the floor cross member can be controlled with a simple structure, and damage to the floor panel at the time of side collision can be suppressed. Further, the impact energy can be absorbed with a simple structure.

According to the present disclosure, it is possible to suppress breakage of the floor panel at the time of a side collision by controlling the folding position of the floor cross member.

### BRIEF DESCRIPTION OF DRAWINGS

FIG. 1 is a plan view showing a floor structure of a vehicle having the vehicle lower structure according to an embodiment;

FIG. 2 is a perspective view showing a vehicle lower structure according to the embodiment;

FIG. 3 is an elevational cross-sectional view of the vehicle lower structure according to the embodiment, and is a cross-sectional view taken along line A-A of FIG. 1;

FIG. 4 is a diagram illustrating a flow of an impact force applied to the vehicle lower structure when the vehicle having the vehicle lower structure according to the embodiment has a side collision;

FIG. 5 is a view showing deformation of the vehicle lower structure when the vehicle having the vehicle lower structure of the embodiment has a side collision;

FIG. 6 is a diagram showing a flow of an impact force applied to a vehicle lower structure when a vehicle having a vehicle lower structure of a prior art, which is a comparative example, has a side collision;

FIG. 7 is a view showing a deformation of a vehicle lower structure when a vehicle having a vehicle lower structure of a prior art, which is a comparative example, has a side collision;

FIG. 8 is a perspective view showing a vehicle lower structure of another embodiment.

### DESCRIPTION OF EMBODIMENTS

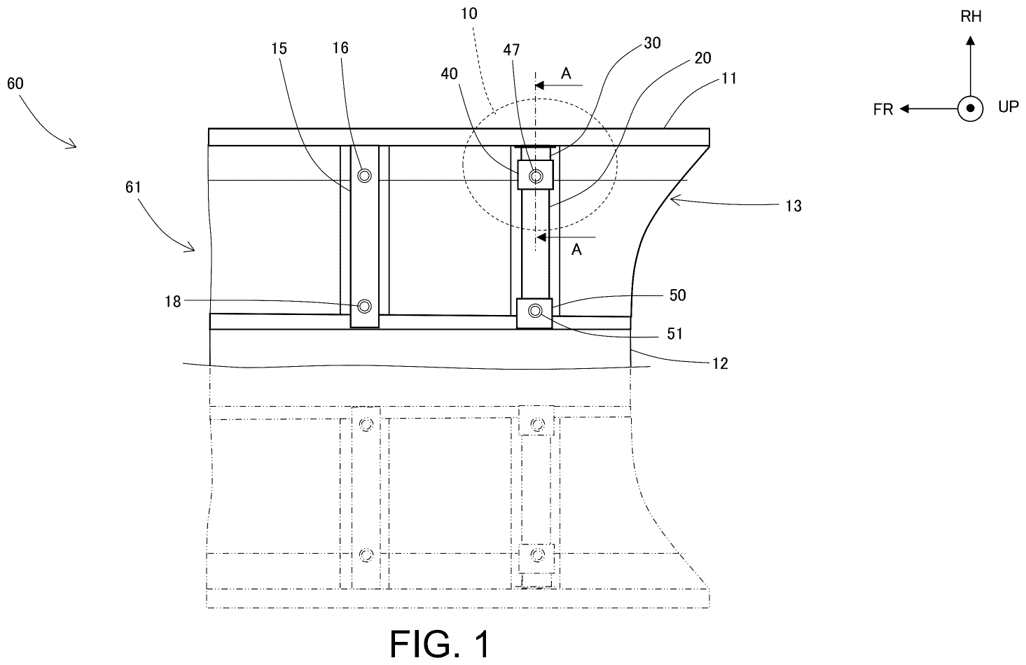

Hereinafter, a vehicle lower structure 10 according to an embodiment will be described with reference to the drawings. First, a floor structure 61 of a vehicle 60 having a vehicle lower structure 10 will be described with reference to FIG. 1. FIG. 1 shows a right side portion of a floor structure 61 of a vehicle 60. Since the left portion of the floor structure 61 is bilaterally symmetric with the right portion of the floor structure 61, only the shape is indicated by a two-dot chain line, and the description thereof is omitted. Note that FR, UP, and RH shown in the drawings indicate a front side, an upper side, and a right side of the vehicle 60, respectively. The opposite directions of FR, UP, and RH indicate the rear side, the lower side, and the left side, respectively. Hereinafter, in the case of simply using the front-rear direction, the left-right direction, and the up-down direction, unless otherwise specified, the front-rear direction, the left-right direction, and the up-down direction of the vehicle 60 are indicated. The front-rear direction is the vehicle longitudinal direction, and the left-right direction is the vehicle width direction.

As shown in FIG. 1, the floor structure 61 of the vehicle 60 includes a rocker 11, a floor tunnel 12, a front floor cross member 15, a rear floor cross member 20, and a floor panel 13. The vehicle lower structure 10 is a structure of a connecting portion between the rear floor cross member 20 and the rocker 11. The vehicle lower structure 10 includes a rocker 11, a floor cross member 20, a gusset 30, and a seat bracket 40.

The rocker 11 is a frame member that is disposed at a side portion of the vehicle 60 and extends in the vehicle front-rear direction. The floor tunnel 12 is a folded plate member that is disposed at the center in the vehicle width direction and extends in the vehicle front-rear direction. The floor tunnel 12 is a longitudinal member having a groove-shaped cross section that is convex upward and is open downward. A power transmission device, a high-voltage cable, and the like extending in the front-rear direction of the vehicle are accommodated in the floor tunnel 12. The front floor cross member 15 and the rear floor cross member 20 connect the rocker 11 and the floor tunnel 12 in the vehicle width direction. Bolt holes 16 and 18 for fixing a front seat (not shown) are provided in the vicinity of the rocker 11 of the front floor cross member 15 and in the vicinity of the floor tunnel 12. A gusset 30 and a seat bracket 40 are attached to the rear floor cross member 20 in the vicinity of the rocker 11. The seat bracket 40 is provided with bolt holes 47 for fixing the front seat. The rear floor cross member 20 is connected to the floor tunnel 12 by a connecting bracket 50. The connecting bracket 50 is provided with bolt holes 51 for fixing the front seat. The floor panel 13 is a plate member that is disposed between the rocker 11 and the floor tunnel 12 and forms a floor of the vehicle cabin.

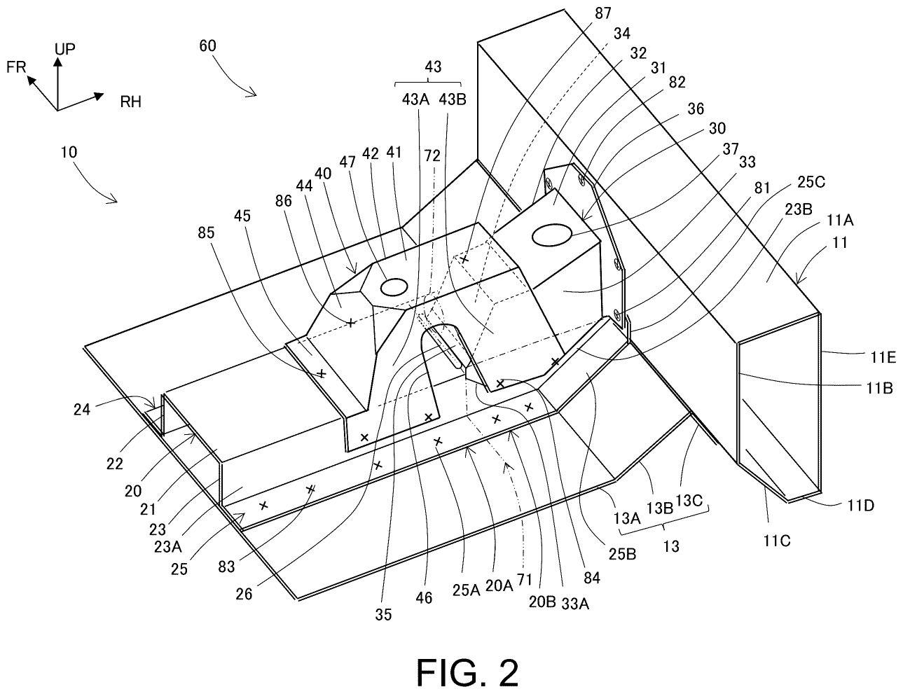

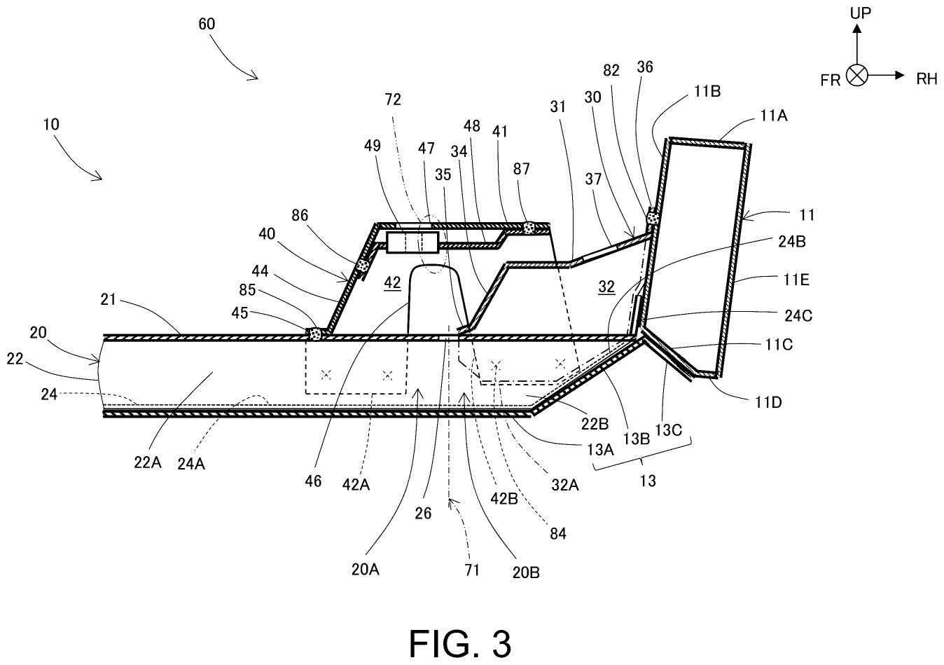

Next, details of the vehicle lower structure 10 included in the right side portion of the floor structure 61 will be described with reference to FIGS. 2 and 3. Note that the vehicle lower structure included in the left side portion of the floor structure 61 is bilaterally symmetrical to the vehicle lower structure 10 included in the right side portion, and thus description thereof is omitted.

As shown in FIGS. 2 and 3, the vehicle lower structure 10 includes a rocker 11, a floor panel 13, a floor cross member 20, a gusset 30, and a seat bracket 40. The rocker 11 is a main structural member having a closed cross-sectional structure including a ceiling plate 11A, an inner plate 11B, an outer plate 11E, a bottom plate 11D, and an inclined plate 11C. The rocker 11 is disposed at a side portion of the vehicle 60 and extends in the vehicle front-rear direction.

The floor panel 13 is a plate member connected to the inclined plate 11C of the rocker 11 and extending inward in the vehicle width direction from the inner plate 11B. The floor panel 13 is a plate member including a rocker connection portion 13C connected to the lower surface of the inclined plate 11C of the rocker 11, a right side portion 13B extending obliquely downward from the lower end of the inner plate 11B of the rocker 11 toward the vehicle width direction inner side, and a floor flat plate portion 13A extending in the horizontal direction.

The floor cross member 20 is a hat-shaped cross-sectional member including a web 21, a front flange 22, a rear flange 23, a front arm 24, and a rear arm 25. The floor cross member 20 is disposed on the floor panel 13 so that the web 21 faces upward. The front flange 22 and the rear flange 23 are plate members erected downward from the front end and the rear end of the web 21. The front arm 24 and the rear arm 25 are plate members extending forward and rearward from lower ends of the front flange 22 and the rear flange 23, respectively. The rear flange 23 includes a main body portion 23A disposed on the floor flat plate portion 13A of the floor panel 13, and a right end portion 23B disposed on the right side portion 13B of the floor panel 13. The lower end of the right end portion 23B is inclined along the right side portion 13B of the floor panel 13. The rear arm 25 includes a flat plate portion 25A connected to the main body portion 23A of the rear flange 23, an inclined portion 25B connected to the right end portion 23B of the rear flange 23, and a connection flange 25C extending upward from the right end of the inclined portion 25B. Similarly, the front flange 22 includes a main body portion 22A and a right end portion 22B, and the front arm 24 includes a flat plate portion 24A, an inclined portion 24B, and a connection flange 24C (see FIG. 3).

The flat plate portion 24A and 25A of the front arm 24 and the rear arm 25 of the floor cross member 20 are connected to the upper surface of the floor flat plate portion 13A of the floor panel 13 by spot welding 83 (indicated by X in the drawing). The connection flange 24C and 25C are connected to the inner plate 11B of the rocker 11 by spot welding 81. The web 21 is disposed at the lower end of the inner plate 11B of the rocker 11. As described above, the floor cross member 20 is connected to the lower portion of the rocker 11, and the front flange 22, the rear flange 23, the front arm 24, and the rear arm 25 are disposed below the lower end of the inner plate 11B of the rocker 11.

The web 21 of the floor cross member 20 is provided with a slit 26 extending in the vehicle front-rear direction. The slit 26 constitutes a strength reduced portion 71 of the floor cross member 20. A portion of the floor cross member 20 on the right side of the slit 26 is referred to as a side end portion 20B of the floor cross member 20, and a portion of the floor cross member 20 on the center in the vehicle width direction of the slit 26 is referred to as a general portion 20A of the floor cross member 20.

The gusset 30 is a reinforcing member connected to the side end portion 20B of the floor cross member 20 and the inner plate 11B of the rocker 11. The gusset 30 includes an upper horizontal plate 31, a front vertical plate 32, a rear vertical plate 33, an end vertical plate 34, a pressing flange 35, and a fixing flange 36. The upper horizontal plate 31, the front vertical plate 32, and the rear vertical plate 33 form a groove-shaped cross section opened downward. The upper horizontal plate 31 is disposed at an upper portion of the side end portion 20B of the floor cross member 20. The front vertical plate 32 and the rear vertical plate 33 are connected to the front end and the rear end of the upper horizontal plate 31 and extend downward. The lower portion of the front vertical plate 32 and the lower portion of the rear vertical plate 33 extend downward along the outer surface of the front flange 22 and the outer surface of the rear flange 23 of the side end portion 20B of the floor cross member 20. The lower portion of the front vertical plate 32 and the lower portion of the rear vertical plate 33 are connected to the outer surface of the front flange 22 and the outer surface of the rear flange 23 of the side end portion 20B by spot welding 84. A hole 37 is provided in the upper horizontal plate 31 of the gusset 30.

The end vertical plate 34 is connected to the vehicle width direction inner side of the upper horizontal plate 31 and extends obliquely downward toward the vehicle width direction inner side. The front end and the rear end of the end vertical plate 34 are connected to the front vertical plate 32 and the rear vertical plate 33. The pressing flange 35 is connected to the lower end of the end vertical plate 34. The lower end of the pressing flange 35 is in contact with the upper surface of the web 21 of the floor cross member 20. The lower end of the pressing flange 35 partially overlaps the slit 26. In this manner, the pressing flange 35 constitutes an inner end in the vehicle width direction of the gusset 30 disposed so as to overlap the slit 26 of the floor cross member 20.

The fixing flange 36 is a plate member connected to the right ends of the upper horizontal plate 31, the front vertical plate 32, and the rear vertical plate 33. The fixing flange 36 is fixed to the inner plate 11B of the rocker 11 by spot welding 82. The lower portion of the fixing flange 36 is fixed to the lower portion of the inner plate 11B of the rocker 11 above the floor cross member 20 together with the connection flange 24C of the floor cross member 20 by spot welding 81. As described above, the gusset 30 is connected to the vehicle width direction inner side surface of the inner plate 11B of the rocker 11 above the floor cross member 20.

The seat bracket 40 includes an upper plate 41, a front plate 42, a rear plate 43, an end plate 44, an end flange 45, and a nut holding plate 48. The upper plate 41 is disposed above the gusset 30 so as to be spaced inward in the vehicle width direction from the rocker 11. The front plate 42 and the rear plate 43 are connected to the front end and the rear end of the upper plate 41 and extend downward. The upper plate 41, the front plate 42, and the rear plate 43 constitute an inverted U-shaped cross-sectional member whose lower side is opened. The seat bracket 40 is a longitudinal member extending in the vehicle width direction, and an inverted U-shaped notch 46 is provided at a central portion in the longitudinal direction of each of the front plate 42 and the rear plate 43. The portion of the seat bracket 40 where the notch 46 is provided constitutes the low-strength portion 72 of the seat bracket 40. Accordingly, the low-strength portion 72 of the seat bracket 40 is provided at the center in the longitudinal direction of the seat bracket 40.

The lower portions of the front plate 42 and the rear plate 43 are divided into right lower portions 42B and 43B, which are outer portions in the vehicle width direction than the notch 46, and middle lower portions 42A and 43A, which are inner portions in the vehicle width direction than the notch 46. The right lower portions 42B and 43B extend downward along the outer sides of the front vertical plate 32 and the rear vertical plate 33 of the gusset 30. The right lower portions 42B and 43B are connected to the outer surfaces of the front flange 22 and the outer surfaces of the rear flange 23 of the side end portion 20B together with the front vertical plate 32 and the rear vertical plate 33 by spot welding 84. The middle lower portions 42A and 43A are connected to the outer surface of the front flange 22 and the outer surface of the rear flange 23 of the general portion 20A. As described above, the front plate 42 and the rear plate 43 are attached to the floor cross member 20 so as to straddle the side end portion 20B and the general portion 20A of the floor cross member 20. The front plate 42 and the rear plate 43 are attached to the floor cross member 20 so that the upper plate 41 covers the gusset 30 from above. When the front plate 42 and the rear plate 43 are attached to the floor cross member 20, the position of the low-strength portion 72 of the seat bracket 40 in the vehicle width direction corresponds to the position of the strength reduced portion 71 of the floor cross member 20 in the vehicle width direction.

The end plate 44 is connected to the vehicle width direction inner side of the upper plate 41 and extends obliquely downward toward the vehicle width direction inner side. The front end and the rear end of the end plate 44 are connected to the front plate 42 and the rear plate 43, respectively. The end flange 45 is connected to the lower end of the end plate 44 and extends inward in the vehicle width direction. The end flange 45 is connected to the upper surface of the web 21 of the floor cross member 20 by spot welding 85.

The nut holding plate 48 extends in the vehicle width direction along the upper plate 41 below the upper plate 41, and is fixed to the upper plate 41 and the end plate 44 by spot welding 87 and 86. A nut 49 is fixed to the nut holding plate 48. A bolt (not shown) for fixing a front seat (not shown) is screwed into the nut 49.

As described above, the seat bracket 40 is disposed on the vehicle width direction inner side of the rocker 11 so as to be separated from the rocker 11. The seat bracket 40 is attached to the floor cross member 20 so as to straddle the side end portion 20B and the general portion 20A of the floor cross member 20. The seat bracket 40 covers the gusset 30 from above. The position of the low-strength portion 72 of the seat bracket 40 in the vehicle width direction corresponds to the position of the strength reduced portion 71 of the floor cross member 20 in the vehicle width direction.

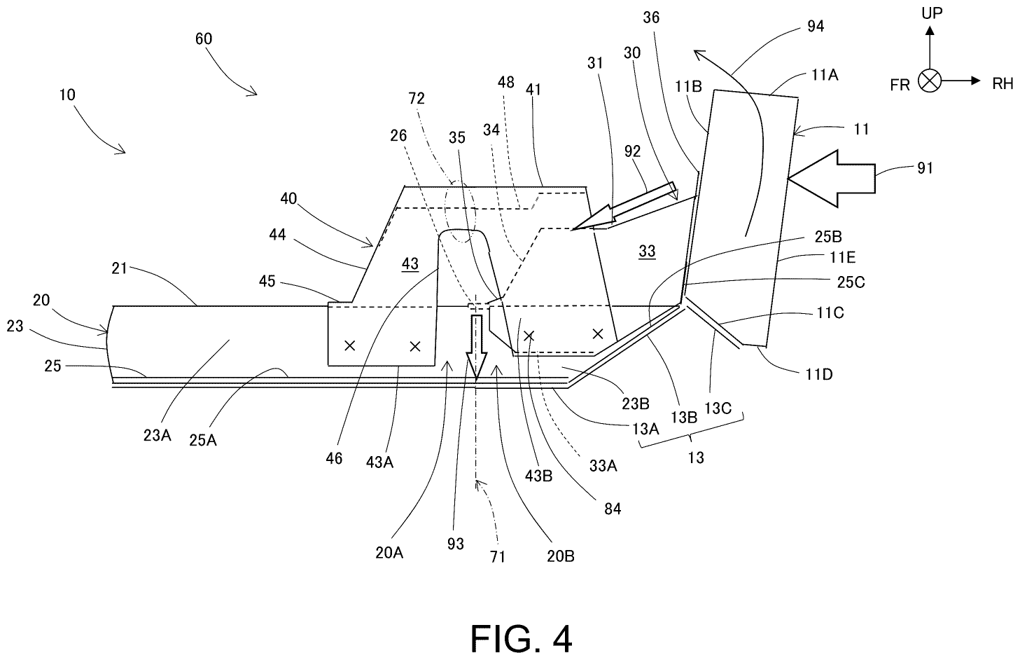

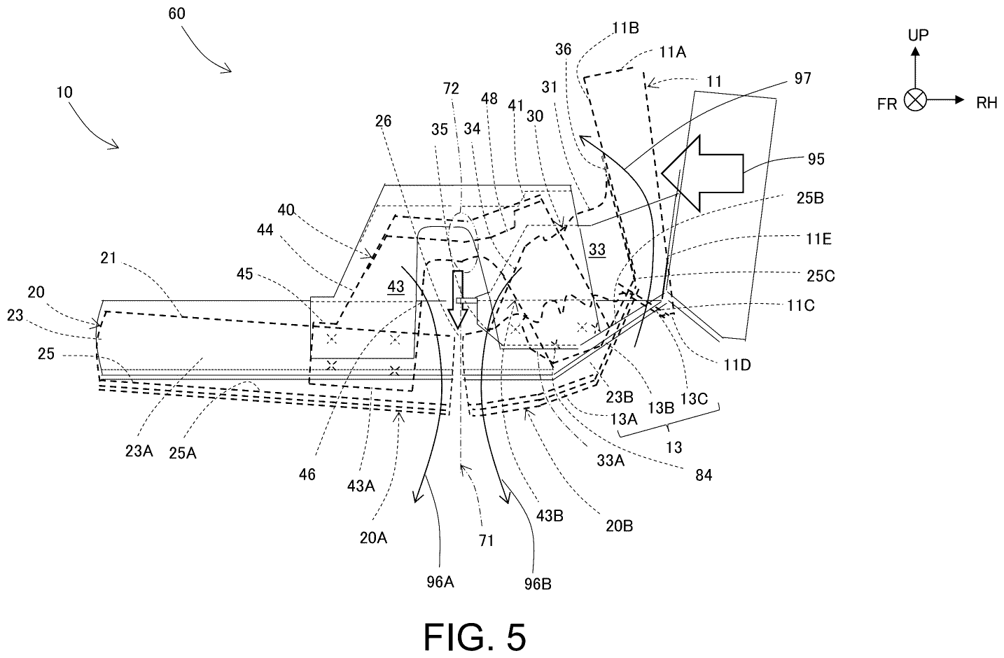

Next, with reference to FIGS. 4 and 5, a flow of impact force at the time of a side collision of the vehicle 60 including the vehicle lower structure 10 configured as described above and deformation of each part of the vehicle lower structure 10 will be described. A broken line in FIG. 5 indicates the vehicle lower structure 10 after deformation.

As described above with reference to FIGS. 2 and 3, the floor cross member 20 is connected to the lower portion of the rocker 11. A left end of the floor cross member 20 is connected to the floor tunnel 12. Therefore, when an impact force is input to the rocker 11 from the right side of the vehicle 60 due to a side collision as indicated by a white arrow 91 in FIG. 4, a rotation moment for rotating the rocker 11 counterclockwise is applied to the rocker 11 as indicated by an arrow 94 in FIG. 4. The rotational moment applied to the rocker 11 becomes a rotational force for rotating the side end portion 20B of the floor cross member 20 counterclockwise.

The impact force input to the rocker 11 is transmitted to the pressing flange 35 through the upper horizontal plate 31 and the end vertical plate 34 of the gusset 30 as indicated by a white arrow 92 in FIG. 4. Then, the pressing flange 35 presses the strength reduced portion 71 of the web 21 downward as indicated by a white arrow 93.

As shown in FIG. 5, the side end portion 20B of the floor cross member 20 is bent and deformed counterclockwise as shown by broken lines and arrows 96B and 97 in FIG. 5 by the downward pressing force from the pressing flange 35 and the rotational force transmitted from the rocker 11. Further, the general portion 20A of the floor cross member 20 is bent and deformed in a clockwise direction as indicated by an arrow 96A and a broken line in FIG. 5 by a downward force from the pressing flange 35. As a result, the floor cross member 20 is bent downward at the strength reduced portion 71.

When the floor cross member 20 is bent downward at the strength reduced portion 71, the right lower portions 42B and 43B of the seat bracket 40 connected to the side end portion 20B of the floor cross member 20 are rotationally deformed counterclockwise together with the side end portion 20B. Further, the middle lower portions 42A and 43A of the seat bracket 40 connected to the general portion 20A of the floor cross member 20 are rotationally deformed clockwise together with the general portion 20A. Therefore, the right lower portions 42B and 43B and the middle lower portions 42A and 43A are deformed so as to open in the vehicle width direction. Accordingly, the front plate 42, the rear plate 43, and the upper plate 41 of the seat bracket 40 are bent downward at the low-strength portion 72.

As described above, when the floor cross member 20 and the seat bracket 40 are bent downward, the rocker 11 moves leftward while rotating counterclockwise. Since the seat bracket 40 is disposed apart from the rocker 11, before the rocker 11 comes into contact with the seat bracket 40, the gusset 30 is rotated counterclockwise and compressed and deformed in the vehicle width direction. When the gusset 30 is deformed so as to collapse in the vehicle width direction, the rocker 11 rotates the seat bracket 40 in the counterclockwise direction and compresses and deforms it in the vehicle width direction. Thus, the floor cross member 20, the gusset 30, and the seat bracket 40 are deformed upward so as to overlap each other. Further, they deform toward the vehicle width direction inner side. Thus, the impact energy is absorbed.

As described above, in the vehicle lower structure 10, when a downward force is transmitted from the gusset 30 to the strength reduced portion 71 at the time of a side collision, the seat bracket 40 is bent downward from the low-strength portion 72. The floor cross member 20 is bent and deformed downward from a strength reduced portion 71 provided at a position corresponding to the low-strength portion 72. As described above, in the vehicle lower structure 10, the bending position of the floor cross member 20 can be controlled in the vicinity of the strength reduced portion 71. Therefore, the vehicle lower structure 10 can reduce the amount of deformation of the floor panel 13 at the time of a side collision.

In addition, in the vehicle lower structure 10, the rocker 11 deforms upward at the time of a side collision. Further, the seat bracket 40 and the floor cross member 20 are bent downward. Then, the seat bracket 40, the floor cross member 20, and the gusset 30 are deformed upward so as to overlap each other. Further, they deform toward the vehicle width direction inner side. Thus, impact energy can be absorbed.

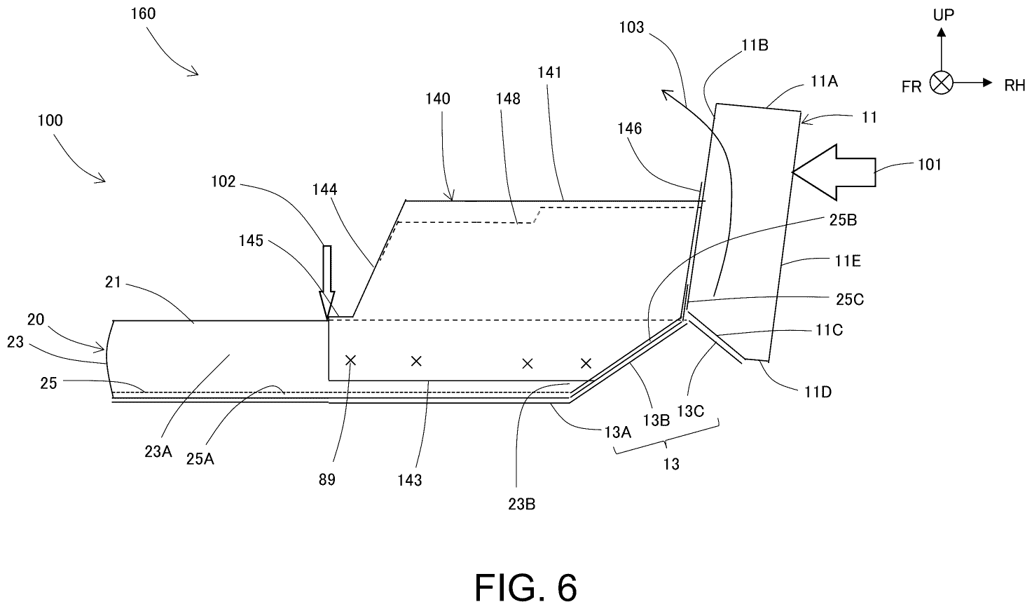

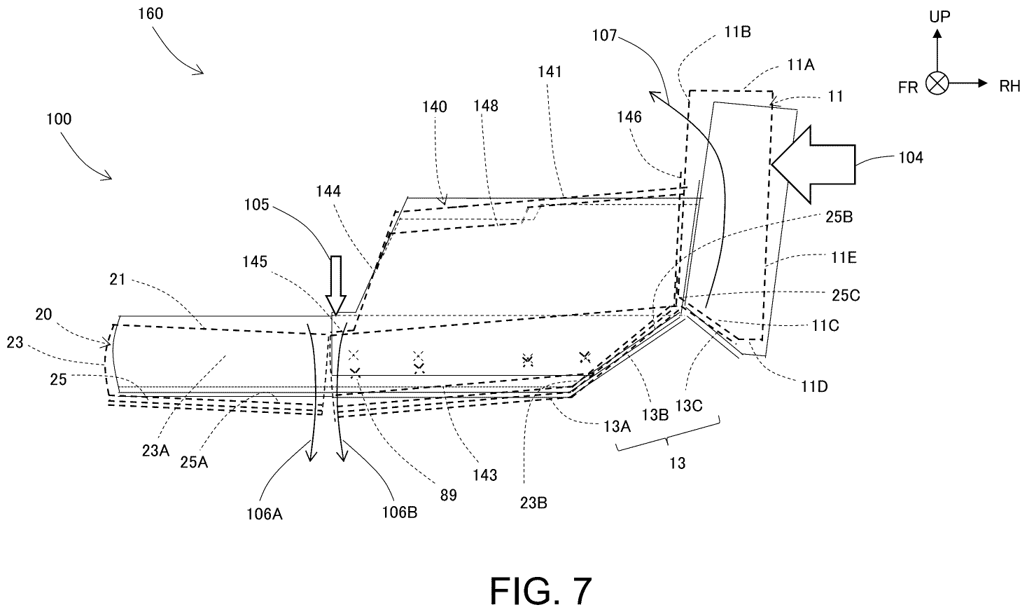

Next, with reference to FIGS. 6 and 7, a description will be given of a vehicle lower structure 100 according to the related art, a configuration of a vehicle 160 having the vehicle lower structure 100, and deformation of the vehicle lower structure 100 when the vehicle 160 has a side collision. Here, unlike the vehicle lower structure 10, the vehicle lower structure 100 of the related art does not include the strength reduced portion 71 and the low-strength portion 72, and does not control the bending position of the floor cross member 20. The same parts as those of the vehicle lower structure 10 described above with reference to FIGS. 1 to 5 are denoted by the same reference numerals, and description thereof will be omitted. A broken line in FIG. 7 indicates the vehicle lower structure 100 after deformation.

As shown in FIG. 6, the vehicle lower structure 100 includes a rocker 11, a floor panel 13, a floor cross member 20, and a seat bracket 140. The vehicle lower structure 100 does not include the gusset 30. The upper plate 141, the front plate (not shown), and the rear plate 143 of the seat bracket 140 are connected to the inner plate 11B of the rocker 11 via the fixing flange 146. The front plate and the rear plate 143 are fixed to the front flange 22 and the rear flange 23 of the floor cross member 20 by spot welding 89. The end flange 145 connected to the lower end of the end plate 144 is fixed to the upper surface of the web 21 of the floor cross member 20 by spot welding (not shown).

When an impact force is input to the rocker 11 as indicated by a white arrow 101 in FIG. 6 due to a side collision of the vehicle 160 including the vehicle lower structure 100 configured as described above, a counterclockwise rotation moment is applied to the rocker 11 as indicated by an arrow 103 in FIG. 6. The rotation moment applied to the rocker 11 rotates the seat bracket 140 counterclockwise. Accordingly, a downward force as indicated by the white arrow 102 is applied to the end flange 145 of the seat bracket 140.

Then, by the downward force, as indicated by broken lines and arrows 106B and 107 in FIG. 7, the portion of the floor cross member 20 on the right side of the end flange 145 and the seat bracket 140 are bent and deformed counterclockwise. The portion of the floor cross member 20 on the left side of the end flange 145 is bent and deformed clockwise as indicated by an arrow 106A. Accordingly, the seat bracket 140 and the floor cross member 20 are bent downward at the position of the end flange 145.

As described above, when the floor cross member 20 is bent downward at the position of the end flange 145, the portion of the floor cross member 20 on the right side of the end flange 145 and the seat bracket 140 are bent and deformed counterclockwise. As a result, the end portion of the floor cross member 20 on the rocker 11 side moves upward. At this time, the floor panel 13 connected to a portion of the floor cross member 20 on the right side of the end flange 145 rolls upward. As a result, the floor panel 13 is damaged.

On the other hand, in the vehicle lower structure 10 shown in FIG. 5, at the time of a side collision, the seat bracket 40 and the floor cross member 20 are bent and deformed downward at the strength reduced portion 71 and the low-strength portion 72. The length of the floor cross member 20 on the right side of the strength reduced portion 71 is shorter than the portion of the vehicle lower structure 100 on the right side of the end flange 145. Therefore, in the vehicle lower structure 10, the portion of the floor panel 13 that deforms in the upward direction at the time of a side collision becomes shorter than the vehicle lower structure 100, and damage to the floor panel 13 can be suppressed.

As described above, in the vehicle lower structure 10 capable of controlling the folding position of the floor cross member 20, as compared with the vehicle lower structure 100 of the related art in which the folding position of the floor cross member 20 is not controlled, the portion of the floor panel 13 that deforms in the upward direction at the time of a side collision becomes short, and damage to the floor panel 13 can be suppressed.

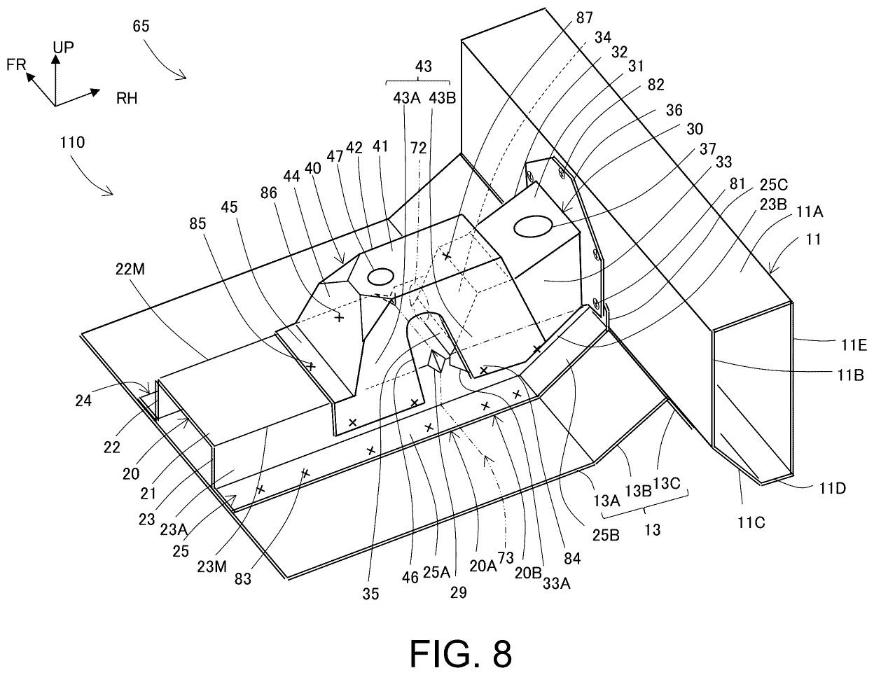

Next, a vehicle lower structure 110 according to another embodiment will be described with reference to FIG. 8. The same portions as those of the vehicle lower structure 10 described above with reference to FIGS. 1 to 5 are denoted by the same reference numerals, and description thereof is omitted.

In the vehicle lower structure 110 shown in FIG. 8, a folded bead 29 is provided in the floor cross member 20 instead of the slit 26. The folded bead 29 is a recess provided in the front connecting ridgeline 22M of the web 21 and the front flange 22, and the rear connecting ridgeline 23M of the web 21 and the rear flange 23. The folded bead 29 constitutes a strength reduced portion 73 of the floor cross member 20.

The transmission and deformation of the impact force of each part when the vehicle 65 having the vehicle lower structure 110 shown in FIG. 8 has a side collision are the same as those when the vehicle 60 having the vehicle lower structure 10 described above has a side collision. The vehicle lower structure 110 has the same functions and effects as those of the vehicle lower structure 10.

In the above description, the slit 26 or the folded bead 29 is provided in the floor cross member 20 as the strength reduced portion 71 and 73. For example, instead of the slit 26, a plurality of holes may be arranged side by side in the vehicle front-rear direction. Further, instead of providing the folded bead 29 on the front connecting ridgeline 22M and the rear connecting ridgeline 23M, the web 21 may be provided with a V-shaped bent portion extending in the vehicle front-rear direction. In addition, although it has been described that the inverted U-shaped notch 46 is provided as the low-strength portion 72, the configuration is not limited thereto as long as the right lower portions 42B and 43B are connected to the side end portion 20B and the middle lower portions 42A and 43A are connected to the general portion 20A. For example, the shape of the notch 46 may be an inverted V-shape, a semicircular shape, or a rectangular shape.

1. A vehicle lower structure comprising:
a rocker disposed on a side portion of a vehicle and extending in longitudinal direction of the vehicle, and
a floor cross member connected to the rocker and extending in a vehicle width direction, and
a gusset connected to a side end portion of the floor cross member and an inner surface of the rocker in the vehicle width direction, and
a seat bracket disposed apart from the rocker and attached to the floor cross member, the seat bracket being attached so as to straddle the side end portion and a general portion of the floor cross member, wherein
the general portion is adjacent to an inner side of the side end portion in the vehicle width direction,
the seat bracket is an elongated member extending in the vehicle width direction, and is provided with a low-strength portion at a center in a longitudinal direction thereof,
the floor cross member is provided with a strength reduced portion at a position corresponding to the low-strength portion, and
the gusset is connected to the side end portion of the floor cross member such that an inner end thereof in the vehicle width direction overlaps the strength reduced portion.

2. The vehicle lower structure according to claim 1, wherein
the floor cross member is connected to a lower portion of the rocker,
the gusset is connected to the inner surface of the rocker in the vehicle width direction above the floor cross member,
the seat bracket is an inverted U-shaped cross-sectional member extending in the vehicle width direction, and is attached to the floor cross member so as to cover the gusset from above.

3. The vehicle lower structure according to claim 2, wherein
the seat bracket is an inverted U-shaped cross-sectional member including a top plate, a front plate, and a rear plate,
the low-strength portion is an inverted U-shaped notch provided in the front plate and the rear plate,
a portion of the front plate at an outer side of the notch in the vehicle width direction and a portion of the rear plate at an outer side of the notch in the vehicle width direction are connected to the side end portion at an outer side of the strength reduced portion in the vehicle width direction, and
a portion of the front plate at an inner side of the notch in the vehicle width direction and a portion of the rear plate at an inner side of the notch in the vehicle width direction are connected to the general portion at an inner side of the strength reduced portion in the vehicle width direction.

4. The vehicle lower structure according to claim 3, wherein
the floor cross member is a hat-shaped cross-sectional member including a web, a front flange, and a rear flange, with the web disposed at an upper position,
the strength reduced portion is a slit provided in the web and extending in the vehicle longitudinal direction.

5. The vehicle lower structure according to claim 3, wherein
the floor cross member is a hat-shaped cross-sectional member including a web, a front flange, and a rear flange, with the web disposed at an upper position,
the strength reduced portion is bent beads provided on a front connecting ridge line between the web and the front flange and on a rear connecting ridge line between the web and the rear flange.
